(19) United States
(12) Patent Application Publication
(10) Pub. No.: US 2013/0115835 A1
(43) Pub. Date: May 9, 2013

(54) Light Weight Magnesium OxyChloride Composition and Construction Board

(71) Applicants: Ronald J. Voit, Elma, NY (US); Mark A. Shand, Findlay, OH (US); Ronald Wardle, Findlay, OH (US)

(72) Inventors: Ronald J. Voit, Elma, NY (US); Mark A. Shand, Findlay, OH (US); Ronald Wardle, Findlay, OH (US)

(73) Assignee: PREMIER MAGNESIA, LLC, Conshohocken, PA (US)

(21) Appl. No.: 13/492,549

(22) Filed: Jun. 8, 2012

Related U.S. Application Data
(60) Provisional application No. 61/494,668, filed on Jun. 8, 2011.

(51) Int. Cl. C08L 25/06; B32B 5/10; B32B 13/02; B32B 5/24

(52) U.S. Cl. CPC C08L 25/06; B32B 5/245; B32B 5/10; B32B 13/02
USPC 442/55; 524/436; 524/35; 442/56

(57) ABSTRACT

A high performance, light weight construction board includes unique low solids Magnesium Oxychloride binder systems filled, Expanded Polymer Beads (EPB) blended with Expanded Perlite and/or with Coal Fuel Fly Ash. Weight reductions for such compositions by incorporating proteinaceous foaming agents into the binder matrix. The use of Calcium and other alkali earth chlorides mixed with magnesium chloride, or totally replacing magnesium chloride, provides unexpected improvements in binder strength. The use of a unique polymer scrim with felt construction provides improved compressive and directional strength properties while also providing superior board pull and shear properties.

### CROSS REFERENCE TO RELATED APPLICATION

This application claims priority to and the benefit of U.S. Provisional Patent Application No. 61/494,668, filed on Jun. 8, 2011, the entire disclosure of which is hereby incorporated by reference in its entirety.

### BACKGROUND OF THE DISCLOSURE

The use of Magnesium OxyChloride (MOC) construction boards are showing considerable global market growth over gypsum boards, Portland cement based boards and other boards due to their ability to be filled with many different materials and provide superior strength, durability, resistance to mold and insects, fire, and other properties. These MOC boards, however, are typically more expensive than other conventional boards. Therefore, to become more cost effective, the need is to formulate boards with a much higher filler concentration to as high as 80%, while lowering the MOC binder solids to as low as 20%. This has been a major challenge as it has been extremely difficult to achieve desirable lighter weights without losing board strength and durability. Therefore, newer MOC binder compositions and different filler combinations were developed to overcome these issues.

### SUMMARY OF THE DISCLOSURE

In accordance with the disclosure, lighter weight construction boards can comprise various Magnesium OxyChloride (MOC) binder systems that maintain high performance. This can be accomplished when using the appropriate mixtures of highly reactive (and sometimes surface treated) grades of Magnesium Oxide with the appropriate grades of alkali earth chlorides. These unique binder systems can be filled with novel mixtures of lightweight fillers and aerating agents proved to provide the desired goals of a more cost effective high performance MOC construction board compared to boards made from Portland cement, gypsum or other cementitious board construction materials.

### DETAILED DESCRIPTION OF PREFERRED EMBODIMENTS

The following compositions are examples of lighter weight MOC boards while achieving required structural board stability. First, a binder matrix was developed by using light calcined, high reactivity, Magnesium Oxide (MgO) that is commercially available through Premier Magnesia, LLC, 300 Barr Harbor Drive, Suite 250, West Conshohocken, Pa. 19428, blended with Magnesium Chloride (MgCl₂) and Water (H₂O) in molar ratios ranging from approximately 5:1:13 to approximately 7:1:17. Once blended with MgCl₂ and H₂O, these “5, 6 and 7 Phase” MOC binders provide considerably higher strength than Portland cement formulations.

To achieve a preferred grade of Magnesium Oxide (MgO) for lighter weight binder systems, a relative pure grade of Magnesite (Magnesium Carbonate) can be lightly burned in, for example, a special kiln at temperatures ranging from 750° to 1,700° F. This produces an MgO of at least 91% purity. Surface treating the Magnesium Oxide with various acids such as concentrated sulfuric acid reacts with any free lime (Calcium Oxide) and converts it to calcium sulfate. Calcium Oxide (CaO) has the tendency to expand very rapidly when in contact with water that is used in the hydration process of the formation of Magnesium OxyChloride (MOC) cements. This acid surface treatment of the MgO substantially reduces potential expansion cracking of the MOC board. Example 1 is a version of such a formula that reduces expansion cracking by incorporating a special acid treated grade of Magnesium Oxide.

### EXAMPLE 1

| Composition: | % by Weight: |
|---|---|
| Acid Surface treated MgO | 22.5 |
| Mg(Cl)₂ Anhydrous | 15.0 |
| Water | 25.0 |
| Expanded Perlite | 12.0 |
| Expanded Polystyrene Beads (EPS) | 3.7 |
| Fly Ash - Class F | 14.4 |
| Glass Beads | 7.4 |

In order to improve the Magnesium OxyChloride (MOC) properties, it was found that mixing Calcium Chloride and other alkali earth chlorides with Magnesium Chloride, totally or substantially replacing Magnesium Chloride was found to provide surprisingly better binder properties. Examples of those alkali earth chlorides that can be used in combination with Magnesium Chloride can be chlorides of Calcium, Potassium, Lithium, or similar chlorides. An example of such a formula that uses mixed alkali earth chlorides is shown in Example 2:

### EXAMPLE 2

| Composition: | % by Weight: |
|---|---|
| MgO - 93% active lightly calcined | 26.5 |
| MgCl₂ Anhydrous | 8.0 |
| CaCl₂ Anhydrous | 12.0 |
| H₂O | 29.0 |
| EPB (Expanded Polymer Beads) | 4.6 |
| Expanded Perlite | 10.7 |
| Fly Ash - Class C | 10.2 |

The discovered increased strengths of these novel MOC binder systems described in Examples 1 and 2, allowed for increased filler usage without overall board strength loss. The higher binder strength also allowed for binder matrix aeration by use of various foaming agents such as, but not limited to Mearlcrete® a product of Cellular Concrete Solutions, 5902 McIntyre Street, Golden, Colo. 80403. The foaming agents that performed best in testing were proteinaceous types, with an example being an aqueous concentrate of a surface active polypeptide-alkylene polyol condensate and stabilized using hydroxyethyl or hydroxypropyl cellulose as shown in Example 3:

### EXAMPLE 3

| Composition: | % by Weight: |
|---|---|
| MgO - 93% active lightly calcined | 20.0 |
| Mg(Cl)₂•6H₂O | 20.8 |
| H₂O | 10.2 |
| Mearlcrete (Aeration additive by Cellular Concrete) | 4.7 |
| Expanded Polymer Beads | 14.3 |
| Expanded Perlite | 10.0 |
| Fly Ash - Class C | 20.0 |

Example filler compositions that allowed for higher board strength and lower weights were based on using either Expanded Polymer Beads (EPB), Expanded Perlite and Coal Fuel Fly Ash in various mix ratios and constituting up to 80% of the actual MOC board weight. Examples of EPB's comprised one or more polymers selected from the group consisting of homopolymers of vinyl aromatic monomers; copolymers of at least one vinyl aromatic monomer with one or more of divinylbenzene, conjugated dienes, alkyl methacrylates, alkyl acrylates, acrylonitrile, and/or maleic anhydride; polyolefins; polycarbonates; polyesters; polystyrene, polyamides; natural rubbers; synthetic rubbers; and combinations thereof. An example a formula containing this product is shown in Example 4.

### EXAMPLE 4

| Composition: | % by Weight: |
|---|---|
| MgO - 93% active lightly calcined | 20.0 |
| MgCl₂•6H₂O | 20.0 |
| H₂O | 10.0 |
| Expanded Polymer Beads (EPB) | 4.7 |
| Expanded Perlite | 20.2 |
| Fly Ash - Class F | 25.1 |

Because some EPB's are not fire resistant themselves by nature of their inherent chemistries, the encapsulating properties of the MOC binder systems help provide fire resistance to the MOC board formulations. It is preferable that the EPB's are well mixed within the MOC board formulation. An example of such a formula that is properly mixed for fire resistance is shown in Example 5:

### EXAMPLE 5

| Composition: | % by Weight: |
|---|---|
| MgO - 93% active lightly calcined | 27.5 |
| MgCl₂•6H₂O | 22.5 |
| H2O | 12.0 |
| EPB | 15.8 |
| Expanded Perlite | 9.7 |
| Fly Ash - Class F | 12.5 |

In addition to discovering improved MOC binder matrices with compatible filler blends, the overall strength of the boards in accordance with the disclosure were further strengthened by using various polymer scrim meshes with a felt coating. The purpose of the felt coated scrim is to provide incremental compressive and directional strength properties while also providing superior board pull and shear properties. This scrim mesh is typically applied to both the upper most and bottom most sections within the MOC board material, but also may be used in the middle section of the board itself.

Therefore, there are always at least two scrim sections in each board, and sometimes more if further strength is desired. The scrim materials including reinforcing fabrics made from synthetic fibers such as fiberglass and polyester, or natural fibers, high modulus yarns, or combinations thereof; with a felt layer for board stability. An example of a preferred formulation that demonstrates the performance of this preferred embodiment is as follows in Example 6:

### EXAMPLE 6

| Composition: | % by Weight: |
|---|---|
| MgO - 93% active lightly calcined | 23.8 |
| MgCl₂•6H₂O | 23.8 |
| H₂O | 10.0 |
| EPB | 9.9 |
| Mearlcrete | 4.8 |
| Scrim (Nonwoven 5510/V38/48) - 2 layers | 5.2 |
| Fly Ash - Class F | 22.5 |

1. A light-weight, highly durable Magnesium OxyChloride-based composition comprising:
a low weight binder system including:
low temperature calcined and highly reactive Magnesium Oxide;
at least one of: Magnesium Chloride, Calcium Chloride, or another alkali earth chloride;
water;
at least one of an aeration or foaming agent; and
a filler blend including Expanded Polymer Beads with at least one of Expanded Perlite and/or Fly Ash.

2. The composition according to claim 1, wherein the low weight binder comprises from about 20% to about 80% based on the total weight of the composition.

3. The composition of claim 1, wherein the binder system includes molar ratios of Magnesium Oxide:Alkali Earth Chloride:Water ranging from 5:1:13 to 7:1:17.

4. The composition according to claim 1 wherein the Magnesium Oxide comprises light calcined materials at varying temperatures ranging from 750 degrees F. to 1,700 degrees F.

5. The composition according to claim 2 wherein the Magnesium Oxide is acid treated with an acid.

6. The composition according to claim 1 wherein the Alkali Earth Chloride an Alkali Earth Mineral chloride.

7. The composition according to claim 1, wherein the at least one of an aeration or foaming agents comprises an aqueous concentrate of a surface active polypeptide-alkylene polyol condensate and stabilized using hydroxyethyl or hydroxypropyl cellulose.

8. The composition according to claim 1 wherein the filler comprises at least one of: a blend including at least one of Expanded Polymer Beads (EPB) blended with Expanded Perlite, EPB blended with Fly Ash or EPB blended with Expanded Perlite; and Fly Ash.

9. The composition according to claim 8, wherein the Expanded Polymer Beads comprise at least one polymer selected from the group consisting of: homopolymers of vinyl aromatic monomers; copolymers of at least one vinyl aromatic monomer with one or more of divinylbenzene, conjugated dienes, alkyl methacrylates, alkyl acrylates, acrylonitrile, and maleic anhydride; polyolefins; polycarbonates; polyesters; polystyrene, polyamides; natural rubbers; synthetic rubbers.

10. A Magnesium OxyChloride-based construction board having an upper face and a lower face, comprising:
a low weight binder system including:
low temperature calcined and highly reactive Magnesium Oxide;
at least one of: Magnesium Chloride, Calcium Chloride, or another alkali earth chloride;
water;
at least one of an aeration or foaming agent;
a filler blend including Expanded Polymer Beads with at least one of Expanded Perlite or Fly Ash; and
a scrim fabric comprising reinforcing fabrics including synthetic fibers and a felt layer positioned over the upper and the lower faces.

11. The composition of claim 4, wherein the Magnesium Oxide has a purity of at least 91% Magnesium Oxide.

12. The composition of claim 6, wherein 1 wherein the Alkali Earth Mineral chloride comprises at least one of: Magnesium Chloride, Calcium Chloride, Potassium Chloride, Lithium Chloride.

13. Magnesium OxyChloride-based construction board according to claim 10, wherein the scrim comprises at least one of fiberglass fibers, polyester fibers, natural fibers, or high modulus yarns.
